(19) United States
(12) Patent Application Publication
(10) Pub. No.: US 2015/0106139 A1
(43) Pub. Date: Apr. 16, 2015

(54) INTEGRATED REPORTING SYSTEM

(71) Applicant: Caterpillar Inc., Peoria, IL (US)

(72) Inventors: Phillip A. Jones, Brisbane (AU); Darryl V. Collins, Jindalee (AU)

(73) Assignee: Caterpillar Inc., Peoria, IL (US)

(21) Appl. No.: 14/578,529

(22) Filed: Dec. 22, 2014

(51) Int. Cl. G06Q 10/06; G06F 17/30

(52) U.S. Cl. CPC G06Q 10/063; G06F 17/30563
USPC 705/7.11

(57) ABSTRACT

An integrated reporting system for a dimensional data associated with a worksite management system is provided. The integrated reporting system includes an extraction and transformation module configured to connect to a plurality of sources. The extraction and transformation module is configured to identify a source data from each of the plurality of sources. The extraction and transformation module is also configured to perform a transformation on the source data to convert the source data into a target data based on the identification. The target data includes a derived result. The extraction and transformation module is further configured to store the derived result into a target database. The integrated reporting system includes a reporting module operatively connected to the target database, wherein the reporting module is configured to generate reports based on the derived result.

### TECHNICAL FIELD

The present disclosure relates to an integrated reporting system, and more particularly to an integrated reporting system operatively connected to a plurality of source systems to generate data reports associated with machine operations.

### BACKGROUND

Different types of data related to a particular machine may be stored in various independent systems. Each of these systems may have a different architecture and system capability resulting in extraction of machine information from this data. In order to generate customer based reports, a reporting tool is utilized to access this data associated with each of these systems. Current solutions require usage of different reporting tools in order to access the data stored on systems having different capabilities.

Accordingly, data users may find it difficult to collate and consolidate the data from each of these systems. Further, the users may require knowledge of using each of the different reporting tools, thereby leading to a cumbersome, time consuming, costly, and complex procedure for extracting and merging the data from these individual systems.

U.S. Pat. No. 6,611,755 describes a vehicle fleet management information system that identifies location and direction of movement of each vehicle in a fleet in real-time, and automatically reports such information, as well as status of predetermined events in which the vehicle is engaged, directly to the fleet manager. Each fleet vehicle has an assigned time slot to transmit its reporting information over a communications network without interfering with transmissions from other vehicles in their own respective time slots. A timing control phase lock loop (PLL) provides precise time synchronization for timing corrections from a global positioning system (GPS) based time reference. A dual band full-duplex interface of the network has TDMA on one-half and broadcast on the other half. Microprocessor time processing units in components of the network perform precise clock synchronization. Space diversity performed on received vehicle transmitted messages avoids data corruption. Different vehicles have different periodic transmission intervals, by dynamically allocating the slots for various update rates. Auxiliary reporting slots enable prompt reporting of important data by the respective vehicle transmitters independent of the slower periodic transmission intervals.

### SUMMARY OF THE DISCLOSURE

In one aspect of the present disclosure, an integrated reporting system for a dimensional data associated with a worksite management system is provided. The dimensional data includes at least one of machine information, worksite information, personnel information, or a combination thereof. The integrated reporting system includes an extraction and transformation module configured to connect to a plurality of sources. The plurality of sources including a plurality of source databases, a plurality of source services, or a combination thereof. The extraction and transformation module is configured to identify a source data from each of the plurality of sources. The extraction and transformation module is also configured to perform a transformation on the source data to convert the source data into a target data based on the identification. The target data includes a derived result. The derived result is based on deriving production information associated with the dimensional data from the source data. The derived result is also based on deriving productivity metrics associated with the dimensional data from the source data. The derived result is further based on deriving characteristic data associated with the dimensional data from the source data. The extraction and transformation module is further configured to store the derived result into a target database. The integrated reporting system includes a reporting module operatively connected to the target database, wherein the reporting module is configured to generate reports based on the derived result.

Other features and aspects of this disclosure will be apparent from the following description and the accompanying drawings.

### BRIEF DESCRIPTION OF THE DRAWINGS

FIG. 1 is a block diagram of an exemplary environment for implementing the present disclosure, according to one embodiment of the present disclosure; and

FIG. 2 is a block diagram of an exemplary integrated reporting system, according to one embodiment of the present disclosure.

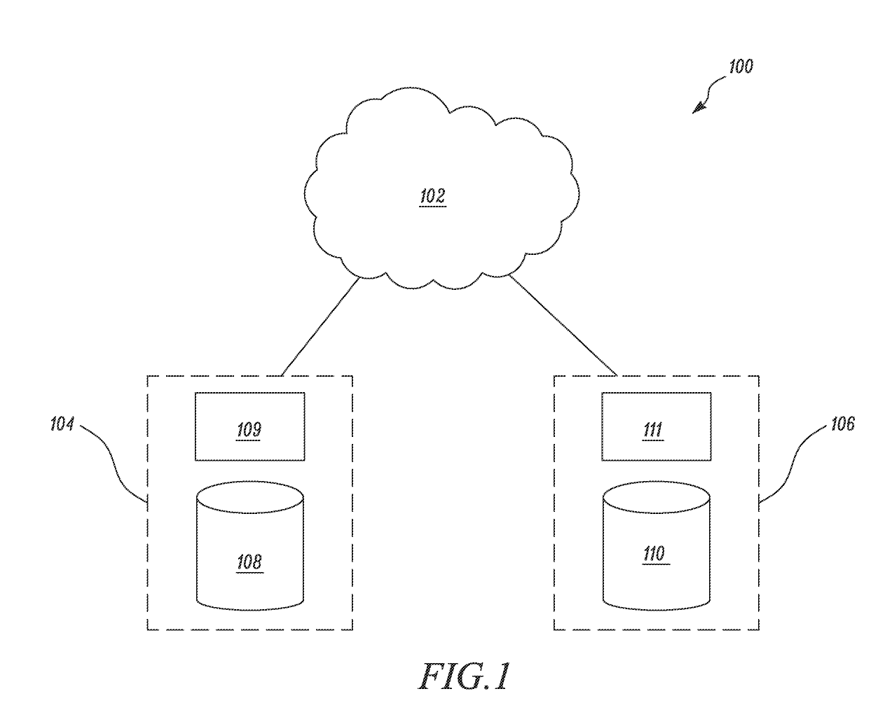

### DETAILED DESCRIPTION

Wherever possible, the same reference numbers will be used throughout the drawings to refer to the same or the like parts. With reference to FIG. 1, an exemplary environment 100 for implementing the present disclosure is depicted. In one example, the environment 100 may be employed across a plurality of worksites spanning different geographical locations, having a number of different machines deployed thereon. The machines may be configured to perform different tasks on the worksite, for example some machines may be used to transport material from one location to another on the worksite. The machines may include, but not limited to, a mining truck, a haul truck, an on-highway truck, an off-highway truck, an articulated truck, and the like. Further, the machines may also include a number of different loading machines configured to load the material onto the other machines. The type of loading machines may include, but not limited to, a conveyor, a large wheel loader, a track-type loader, a shovel, a dragline, a crane, and the like.

The environment 100 includes a first system 104 and a second system 106 associated with a worksite management system. The first and second systems 104, 106 are associated with managing a dimensional data associated with the worksite management systems. For example, the first and second systems 104, 106 may store and manage data related to machine information of the different machines, worksite information related to the worksite on which the different machines operate, personnel information related to crew or designated work staff operating the different machines, or a combination thereof. Accordingly, the dimensional data may include machine information, worksite information, personnel information, or a combination thereof.

The first and second systems 104, 106 may be communicably coupled to each other via a network 102. Examples of the network 102 may include, but are not limited to, a wide area network (WAN), a local area network (LAN), an Ethernet, Internet, an Intranet, a cellular network, a satellite network, or any other suitable network for transmitting data. In various embodiments, the network 102 may include a combination of two or more of the aforementioned networks and/or other types of networks known in the art. Further, the network 102 may be implemented as a wired network, a wireless network, or a combination thereof. Further, data transmission make take place over the network 102 with a network protocol such that the data transmission is in an encrypted format, any other secure format, or in any of a wide variety of known manners.

The first and second systems 104, 106 may include a first source database 108 or first source service 109 and a second source database 110 or second source service 111 respectively associated therewith. One of ordinary skill in the art will appreciate that although only the first and second systems 104, 106 are described herein, the environment 100 may include any number of systems, based on the type of applications. For example, the environment 100 may include at least one of a terrain management system, a fleet management system, a machine detection system, an autonomous machine control system, a semi-autonomous machine control system, a reporting system associated with fleet management applications, an integrated machine control system, a machine health monitoring system, a command system, and so on. Further, the number of source databases 108, 110 or source services 109, 111 associated with the systems 104, 106 may also vary. It should be noted that the first and second systems 104, 106 disclosed herein in the context of the present disclosure are distinct from each other with respect to their architecture, data storage capabilities, type of data stored therein, data formats, and have distinct system implementation and functionality.

In the present disclosure, the first system 104 may embody a terrain management system. The first source database 108 of the first system 104 may store and process data related to a terrain of the worksite on which the machines operate. The first source database 108 may be configured to store and maintain updated surface data associated with the worksite. The term “surface data” used herein refers to terrain information and other parameters associated with the worksite. For example, the surface data may include, but not limited to, an elevation, object detection, radio network signal strength, and other geospatial aspects of the worksite.

In one embodiment, based on the surface data, a surface model of the worksite may be generated and stored in the first source database 108, using any known technique in the art. Further, the first source database 108 may be configured to store the updated surface data, wherein the updated surface data includes a latest or updated version of the surface data associated with the worksite. Different levels of granularity or resolution of the surface data may also be maintained within the first source database 108. The first source database 108 may further store a digital map indicative of compaction of the worksite as a function of the history of travel of one or more machines across the worksite.

The second system 106 may embody a machine fleet management system. The second system 106 may be associated with information related to the machines operating on the worksite, and may be used for asset management and for providing an interface for controlling or accessing information related to an operation of a fleet of the machines from a remote location. For example, the machines are equipped with a number of sensors for detecting various machine parameters, positioning of the machine on the worksite, and other characteristic data during working. The second system 106 may involve gathering data regarding the fleet, managing and interpreting the data and machine maintenance, understanding how and when to maintain a machine, i.e., perform preventative maintenance, and coordinating all of the activity surrounding or going into the maintenance of a single machine.

The second system 106 may further store information regarding location and direction of movement of each machine in the fleet as well as status of predetermined events in which the machine is engaged. In one embodiment, the machines are equipped with a plurality of sensors for detecting information regarding characteristics of the machine itself, for e.g., speed, steering angle, orientation such as pitch and roll, geographical location, load weight, and load distribution. The second system 106 may include means for monitoring, recording, conditioning, storing, indexing, processing, and/or communicating information received from these sensors associated with the machines and store this information in the second source database 110.

Accordingly, the first and second source databases 108, 110 or first and second source services 109, 111 hereinafter interchangeably referred to as a plurality of sources 108, 109, 110, 111 may serve as sources of information stored or processed by the first and second systems 104, 106 respectively. The first and second source databases 108, 110 may store different aspects of the source data associated with the first and second systems 104, 106 respectively. The source data in the first and second systems 104, 106 may capture different information of the machines, worksite or personnel that are stored on a real time or periodic basis based on the system design. Further, the source data of the first and second systems 104, 106 respectively may include raw data captured directly from the respective system 104, 106. The first and second source services 109, 111 may includes services associated with the dimensional data hosted within the first or second systems 104, 106, external third party systems, or other geographical information systems. In one embodiment, the first and second source services 109, 111 may include, but not limited to, web services. For example the dimensional data associated with the first and second source services 109, 111 may include a set of permissions granted to an autonomous machine to use parts of a road network.

A person of ordinary skill in the art will appreciate that the first and second systems 104, 106 described herein are exemplary in nature and do not limit the scope of the present disclosure. The functionality of the first and second systems 104, 106 described herein is also exemplary. The first and second systems 104, 106 may additionally include other components and capabilities not described herein. The environment 100 may additionally include any number of systems. Further, the architecture and capabilities of these systems may vary without any limitation.

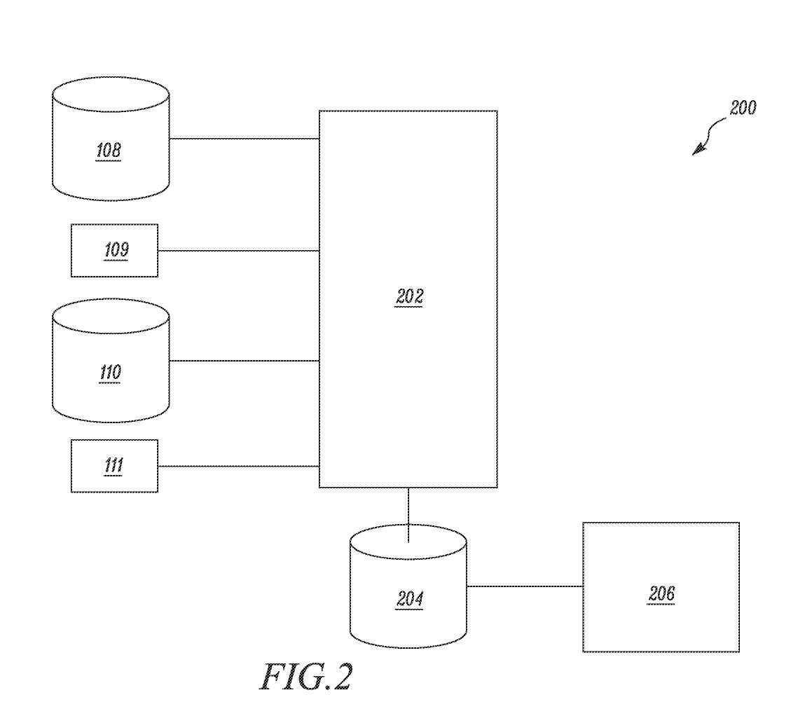

The present disclosure relates to an integrated reporting system 200 (see FIG. 2) for reporting data from a plurality of systems in a consolidated manner, irrespective of the underlying system capability and architecture, using a single reporting module. Referring to FIG. 2, the integrated reporting system 200 includes an extraction and transformation module 202. The extraction and transformation module 202 may be communicably coupled to the plurality of sources 108, 109, 110, 111 of the first and second systems 104, 106 respectively. One of ordinary skill in the art will appreciate that the plurality of sources 108, 109, 110, 111 is not limited to that described herein, and the extraction and transformation module 202 may stream the dimensional data or the source data from any suitable source based on the system requirements.

The dimensional data or the source data may include different information, based on the system functionality. For example, the source data may include manual entry of information related to a mine site, such as, definition of shift start time and shift end time, persons or personnel assigned to a crew for the shift, the crew allocated to the shift, total mine target tonnes for the machines to move during the shift based on a mine plan, schedule for the machines to go to maintenance bay for scheduled maintenance, and so on. Further, the source data may include fuel tracking information associated with the machines related to an amount of fuel dispensed into the machines, time of starting of fuel dispense, time of ending of fuel dispense, name of the crew who dispensed fuel. The source data may relate to personnel location tracking information associated with records data of location of the crew when the crew arrive at or depart from the machines, site weather station information relating to records of temperature at the worksite, humidity at the worksite, ground vibration, personnel health records, and so on.

The extraction and transformation module 202 is configured to retrieve and process the source data from the plurality of sources 108, 109, 110, 111 for transforming the source data into a target data. Various types of transformations may be performed on the source data to derive results therefrom, either separately or in combination, in order to change the source data to the target data in such a manner that the consolidated target data from the plurality of systems may be further utilized to generate reports therefrom. Some of the transformation steps performed by the extraction and transformation module 202 will now be described in the context of the present disclosure.

Accordingly, the extraction and transformation module 202 is configured to identify the source data from the plurality of sources 108, 109, 110, 111. Based on identifying the source data, the extraction and transformation module 202 may categorize the source data into various information buckets or pools in order to segregate or differentiate between different aspects of the machine information stored across the different systems 104, 106. Some of the source data may be categorized into a plurality of pools, based on the extent of information that may be extracted or derived therefrom. It should be noted that the extraction and transformation module 202 may be programmed to selectively extract and identify the source data that that may be considered as relevant to a particular application.

The identification of the source data may allow the extraction and transformation module 202 to filter out or discard some aspects of the machine information from further processing. By identifying that the source data is critical and should not undergo further transformation thereof, a level of data security may be provided and prevent users from having access to such critical information. Further, some of the source data may be discarded as being unimportant for the later report generation phase. Accordingly, based on the identification of the source data, the extraction and transformation module 202 may omit performing the transformation of the critical and unimportant source data and thereby provide optimum processing of the source data. One of ordinary skill in the art will appreciate that different systems may provide source data that may fall under a plurality of categories, and thus, by identification thereof, the extraction and transformation module 202 may determine which transformation steps to apply to the source data to accordingly derive meaningful information therefrom and convert the source data into the target data.

Further, the extraction and transformation module 202 is configured to perform the transformation of the source data extracted from the plurality of sources 108, 109, 110, 111, in order to convert the source data into the target data based on the identification of the source data. Accordingly, the extraction and transformation module 202 is configured to perform various processing steps on the source data in order to derive results therefrom and store the derived results obtained from the plurality of sources 108, 109, 110, 111 into a target database 204 coupled to the extraction and transformation module 202. These derived results may be retrieved and accessed by a reporting module 206. The reporting module 206 may be seamlessly integrated with the plurality of sources 108, 109, 110, 111 irrespective of the underlying system architecture and capabilities, via the extraction and transformation module 202.

The extraction and transformation module 202 may be configured to derive production information associated with the dimensional data from the source data received from the plurality of sources 108, 109, 110, 111. For example, the extraction and transformation module 202 may receive the source data regarding type of operations that the machines may have performed in the past. In an exemplary embodiment, wherein the machine is a wheel loader, a loading cycle may occur wherein a certain amount of payload may be loaded by the wheel loader on to a dump truck. The extraction and transformation module 202 may receive the source data indicative of the amount of payload that the wheel loader dumps in order to derive the production information therefrom. It should be noted that the extraction and transformation module 202 may derive the production information indicative of various operations performed by the plurality of machines, as and when required. In one embodiment, the extraction and transformation module 202 may also make assumptions about current activities or future activities of the machines.

The extraction and transformation module 202 may also be configured to derive utilization information associated with the dimensional data from the source data. The utilization information may be indicative of time based information associated with the plurality of machines, indicative of, for example, productive work performed by the machines during defined shift cycles. In one example, the utilization information may be derived by the extraction and transformation module 202 from the source data by computing the amount of payload transported by the machine, utilization of the machine in the shift cycle, downtime of the machine, and so on. Based on the system architecture, this utilization information may be extracted, computed, derived, or processed data obtained from the source data involving other complexities or parameters associated with the system 104, 106 not described herein, for example, terrain obstructions on the worksite, work route or working zones of the machines, and so on. Further, the extraction and transformation module 202 may also calculate and store data related to other dimensional data, for example, the crew, the geographical locations, and so on.

In another exemplary embodiment, the extraction and transformation module 202 may be configured to derive productivity metrics for the dimensional data, either separately or based on the derived production information and the utilization information. The productivity metrics may be indicative of an efficiency of the machines based on the tasks performed. For example, the productivity metrics for the wheel loader may be a ratio between the amounts of payload dumped during the loading operation to the operating time of the wheel loader during the loading operation. The productivity metrics may involve consideration of a plurality of factors for determination thereof as will be appreciated by one of ordinary skill in the art.

The extraction and transformation module 202 may also derive characteristic data associated with the dimensional data from the source data. For example, the extraction and transformation module 202 may derive threshold speed limits, surface temperature of components of the machine, inflation thresholds of the wheels, pressure within accumulators of the machine, and also within combustion chambers of engine of the machine, fuel consumption, position of the machine on the worksite, and so on from the raw source data obtained from the plurality of sources 108, 109, 110, 111. It should be noted that the transformations and derivations performed by the extraction and transformation module 202 described above are exemplary and non-limiting. The extraction and transformation module 202 may be further configured to transform the source data and derive a plurality of other results from the source data other than that described herein. For example, the extraction and transformation module 202 may derive results from the source data so that mine managers may understand the quantity and quality of material moved from one location of the mine site to a different location of the mine site. In another example, the extraction and transformation module 202 may derive results from the source data so that personnel who operate the machines may understand the individual's own performance during the shift. In yet another example, the extraction and transformation module 202 may derive results from the source data so that crew supervisor may understand the performance of their crew consisting of a number of individuals.

Further, the extraction and transformation module 202 is configured to store the derived results obtained from the plurality of sources 108, 109, 110, 111 into the target database 204. The target database 204 may include consolidated data derived by the extraction and transformation module 202 from the plurality of sources 108, 109, 110, 111. The results may include one or more of the derived results of the production information, the utilization information, the productivity metrics, the machine characteristic data, personnel data, weather data, other characteristic data, or any other combination thereof, or other information associated with the system 104, 106 that may be apparent to one of ordinary skill in the art.

It should be noted that the first and second source databases 108, 110 and the target database 204 may include any type of database, such as relational, hierarchical, spatial, temporal, graphical, object-oriented, and/or other database configurations. Common database products that may be used to implement the source databases 108, 110 may include DB2 by IBM (White Plains, N.Y.), various database products available from Oracle® Corporation (Redwood Shores, Calif.), Microsoft Access or Microsoft SQL Server by Microsoft Corporation (Redmond, Wash.), OSIPi, PostgreSQL with PostGIS therein, NoSQL databases, or any other suitable database product. Moreover, the first and second source databases 108, 110 and the target database 204 may be organized in any suitable manner, for example, as data tables or lookup tables.

The first and second source databases 108, 110 and the target database 204 may be located at suitable locations based on the system design. Further, the first and second source databases 108, 110 and the target database 204 may employ data distribution and redundancy architectures known to one of ordinary skill in the art. The integrated reporting system 200 includes the reporting module 206. The reporting module 206 configured is communicably coupled to the target database 204. The reporting module 206 is configured to generate the reports based on the derived results stored by the extraction and transformation module 202 in the target database 204. The reporting module 206 may be embodied as a query tool that allows a customer to query the target database 204 and obtain required information therefrom.

The reporting module 206 may include any report generating software known to a person of ordinary skill in the art. The reporting module 206 may facilitate interaction with the target database 204 via a graphic user interface or any other interface known to one of ordinary skill in the art that may be used to query the target database 204 and obtain reports therefrom. These reports may be provided to the customer in any suitable format, for example, the reports may include spreadsheets, maps, charts, graphs, datasheet, statistic curves, data models, diagrams, tables, pictorial representations, or any other graphical or textual output generated by the reporting module 206 that may be known to one of ordinary skill in the art.

The extraction and transformation module 202 may embody a single microprocessor or a plurality of microprocessors for receiving data from the plurality of sources 108, 109, 110, 111 and sending data to the target database 204. Numerous commercially available microprocessors may be configured to perform the functions of the extraction and transformation module 202. It should be appreciated that the extraction and transformation module 202 may embody an electronic controller capable of extracting and analyzing machine data associated with the plurality of machines. A person of ordinary skill in the art will appreciate that the extraction and transformation module 202 may additionally include other components and may also perform other functions not described herein. Further, the functionality of the extraction and transformation module 202 described herein is exemplary, and the extraction and transformation module 202 may additionally perform other operations on the source data from the plurality of sources 108, 109, 110, 111 to transform the source data into the target data.

### INDUSTRIAL APPLICABILITY

The present disclosure is directed towards the integrated reporting system 200. The integrated reporting system 200 includes the extraction and transformation module 202. The extraction and transformation module 202 is configured to extract the source data from the plurality of sources 108, 109, 110, 111. The extraction and transformation module 202 is configured to transform the source data into the target data by deriving results or performing operations thereon.

Further, the extraction and transformation module 202 stores the derived results into the target database 204. The target database 204 is embodied as a consolidated database that is configured to store transformed data therein. The integrated reporting system 200 includes the reporting module 206. The reporting module 206 is configured to connect to the target database 204, and the reporting module 206 is configured to generate reports based on the derived results in the target database 204.

The integrated reporting system 200 of the present disclosure provides a system that allows for generation of reports from the plurality of sources 108, 109, 110, 111, irrespective of underlying system architecture and capabilities. Further, by using a single integrated reporting system, the customer may gain access to the required machine information, worksite information, personnel information, or any combination thereof, and generate combined reports for data obtained from distinct systems. Further, the extraction and transformation module 202 may be utilized to protect certain sensitive information or raw data at the system level, and provide limited access rights to the reporting module 206, thereby providing improved system security and data protection. The customer may thus need to operate the single reporting module 206, instead of learning to use a plurality of query tools, as a one stop solution to obtain machine related reports by querying the target database 204.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An integrated reporting system for a dimensional data associated with a worksite management system, the dimensional data including at least one of machine information, worksite information, personnel information, or a combination thereof, the integrated reporting system comprising:
an extraction and transformation module configured to connect to a plurality of sources, the plurality of sources including a plurality of source databases, a plurality of source services, or a combination thereof, wherein the extraction and transformation module is configured to:
identify a source data from each of the plurality of sources;
perform a transformation on the source data to convert the source data into a target data based on the identification, wherein the target data includes a derived result based on performing at least one of:
deriving production information associated with the dimensional data from the source data;
deriving utilization information associated with the dimensional data from the source data;
deriving productivity metrics associated with the dimensional data from the source data; or
deriving characteristic data associated with the dimensional data from the source data; and
store the derived result into a target database; and
a reporting module operatively connected to the target database, wherein the reporting module is configured to generate reports based on the derived result.
